(19) United States
(12) Patent Application Publication
(10) Pub. No.: US 2014/0313531 A1
(43) Pub. Date: Oct. 23, 2014

(54) INFORMATION PROCESSING APPARATUS

(71) Applicant: OKI DATA CORPORATION, Tokyo (JP)

(72) Inventor: Naosato KOJIMA, Tokyo (JP)

(73) Assignee: OKI DATA CORPORATION, Tokyo (JP)

(21) Appl. No.: 14/249,402

(22) Filed: Apr. 10, 2014

(30) Foreign Application Priority Data
Apr. 18, 2013 (JP) 2013-087637

(51) Int. Cl. G06K 15/00; H04N 1/00; G06F 3/12

(52) U.S. Cl. CPC G06K 15/4055; G06F 3/1221; H04N 1/00896
USPC 358/1.13

(57) ABSTRACT

An information processing apparatus according to the invention includes: a reception unit for receiving data; a reception buffer unit memorizing the data received at the reception unit; a control unit reading out the data from the reception buffer unit and executing a prescribed processing in either a first mode or a second mode having a higher processing ability than that of the first mode; a detection unit for detecting an amount of the data memorized in the reception buffer unit; and a switching unit for switching the first mode to the second mode when the control unit is executing the processing in the first mode, based on a detection result of the detection unit. The information processing apparatus can advantageously suppress occurrences of packet reception failures even where the communication traffic becomes subjecting to heavy load during the first mode.

### CROSS REFERENCE TO RELATED APPLICATION

This application claims priority benefits under 35 USC, section 119 on the basis of Japanese Patent Application No. 2013-087637, the disclosure of which is incorporated herein by reference.

### BACKGROUND OF THE INVENTION

1. Field of the Invention

This invention relates to an information processing apparatus having a sleep mode.

2. Background of Related Art

Conventional information processing apparatuses may have a normal mode and a sleep mode, as operation mode, and during the sleep mode, some apparatuses realize power saving more than that in the normal mode by monitoring the network and performing network responses (see, e.g., Japanese Unexamined Patent Publication No. 2011-254205 (A1)).

With such a conventional art, the apparatus in the sleep mode operates with lower power consumption than that in the normal mode. The apparatus therefore cannot receive packets due to relatively low receiving performance of the packets communicated through the network where a heavy load affects communication traffic of the network, and there arises a problem that reception of such packets may be failed.

It is therefore an object of the invention to provide an information processing apparatus suppressing occurrences of packet reception failures even where a high load affects the communication network during a sleep mode.

### SUMMARY OF THE INVENTION

To solve the above problem, an information processing apparatus according to the invention includes: a reception unit for receiving data; a reception buffer unit memorizing the data received at the reception unit; a control unit reading out the data from the reception buffer unit and executing a prescribed processing in either a first mode or a second mode having a higher processing ability than that of the first mode; a detection unit for detecting an amount of the data memorized in the reception buffer unit; and a switching unit for switching the first mode to the second mode when the control unit is executing the processing in the first mode, based on a detection result of the detection unit.

According to the invention, the information processing apparatus is advantageously capable of suppressing occurrences of packet reception failures even where a high load affects the communication network during the sleep mode.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a block diagram showing an outlined structure of a printer according to a first embodiment of the invention;

FIG. 2 is a block diagram showing a block diagram showing a structure of the printer according to the first embodiment of the invention;

FIG. 3 is an illustration showing a structure of an image forming system according to the first embodiment of the invention;

FIG. 4 is a screen illustration showing a sleep mode setting screen of the printer according to the first embodiment of the invention;

FIG. 5 is an illustration for describing reception FIFO in the printer according to the first embodiment of the invention;

FIG. 6 is an illustration for describing reception FIFO in the printer according to the first embodiment of the invention;

FIG. 7 is an illustration for describing network setting information according to the first embodiment of the invention;

FIG. 8 is an illustration for describing printer's function in the normal mode according to the first embodiment of the invention;

FIG. 9 is an illustration for describing printer's function in the sleep mode according to the first embodiment of the invention;

FIG. 10 is a flowchart showing an initialization processing in the sleep mode according to the first embodiment of the invention;

FIG. 11 is a flowchart showing a processing at occurrence of reception FIFO full interruption in the sleep mode according to the first embodiment of the invention;

FIG. 12 is an illustration for describing printer's function in the sleep mode according to a second embodiment of the invention;

FIG. 13 is an illustration for describing a reception FIFO in the printer according to the second embodiment of the invention;

FIG. 14 is a flowchart showing an initialization processing in the sleep mode according to the second embodiment of the invention;

FIG. 15 is a flowchart showing a processing at occurrence of reception FIFO near-full interruption in the sleep mode according to the first embodiment of the invention;

FIG. 16 is an illustration for describing printer's function in the normal mode according to a third embodiment of the invention;

FIG. 17 is a sleep mode transition time decision table according to a third embodiment of the invention;

FIG. 18 is a flowchart showing a processing for deciding the sleep transition time according to the third embodiment of the invention; and

FIG. 19 is a flowchart showing a processing for deciding the sleep transition time according to a fourth embodiment of the invention.

### DETAILED DESCRIPTION OF EMBODIMENTS

### First Embodiment

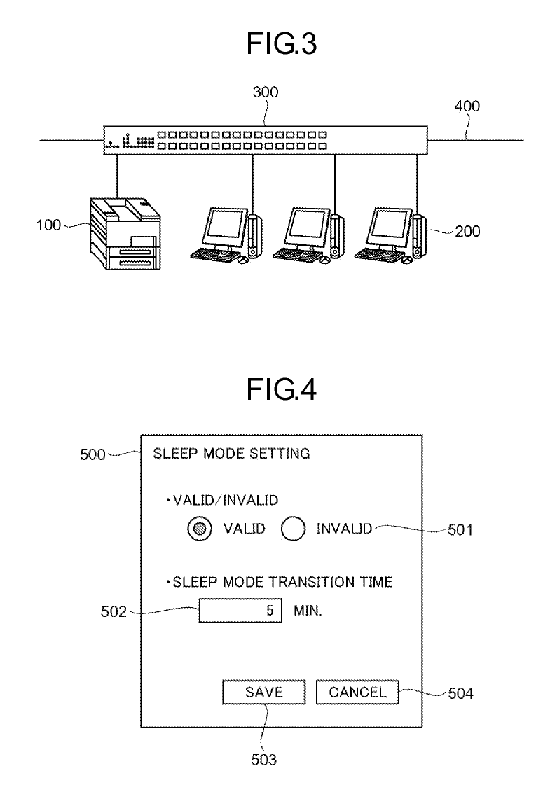

Referring to drawings, an embodiment of an information processing apparatus according to the invention is described. FIG. 3 is a block diagram showing a system structure of an image formation system according to the first embodiment of the invention. In FIG. 3, the information processing system is constituted of a printer 100 serving as an information processing apparatus, PCs (personal computers) 200, a hub 300, and an LAN (Local Area Network) 400.

The printer 100 is an image forming apparatus having a normal mode for printing processings based on printing data and for processings of respective types upon receiving manipulations of an operator, and a sleep mode done with lower power consumption that that in the normal mode. The printer 100 is, e.g., a monochrome or multicolor page printer. The sleep mode means an operation mode saving power in which the printer 100 consumes power less than the normal mode by cutting off or reducing the power supplies to prescribed sections of the printer 100.

The PC 200 is formed of a single or plural personal computers, and each PC 200 transmits a printing job instructing printing to the printer 100 via the LAN 400. The hub 300 is, e.g., a gigabit switching hub, connects the printer 100 and the PCs 200, and is forming the LAN 400. It is to be noted that the LAN 400 may be entered into a heavy load state of the communication traffic due to performance of packets such as broadcast packets and multicast packets transmitted from the plural PCs 200.

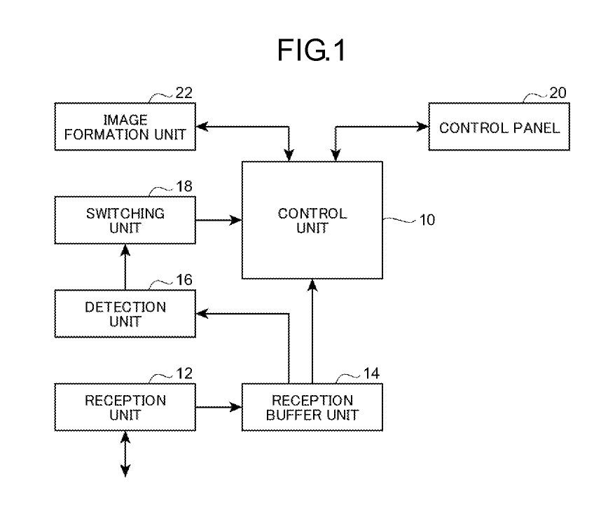

FIG. 1 is a block diagram showing an outlined structure of the printer 100 according to the first embodiment. In FIG. 1, the printer 100 includes a reception unit 12 for receiving data from, e.g., the hub 300, a reception buffer unit 14 memorizing the data received at the reception unit 12, a control unit 10 reading out the data from the reception buffer unit 14 and executing a prescribed processing in either a sleep mode or a normal mode, a detection unit 16 for detecting an amount of the data memorized in the reception buffer unit 14, and a switching unit 18 for switching, based on a detection result of the detection unit 16, the sleep mode to the normal mode while the control unit 10 is executing the processing in the sleep mode. With this printer 100, the normal mode is an operation mode having a higher processing ability in the control unit 10 than that of the sleep mode.

The printer 100 further includes an image formation unit 22 for forming images on a medium according to the processing done with the control unit 100, and a control panel 20 for displaying various buttons for receiving entries from the operator and displaying various states of the printer 100.

The detection unit 16 detects that an amount of the data memorized in the reception buffer unit 14 reaches a prescribed amount. The prescribed amount serves as a threshold value for switching the sleep mode to the normal mode. The prescribed amount is a full amount of data capacity of the reception buffer unit 14 or a nearly-full amount of data capacity of the reception buffer unit 14. The prescribed amount may be changeable according to user's manipulation using the control panel 20.

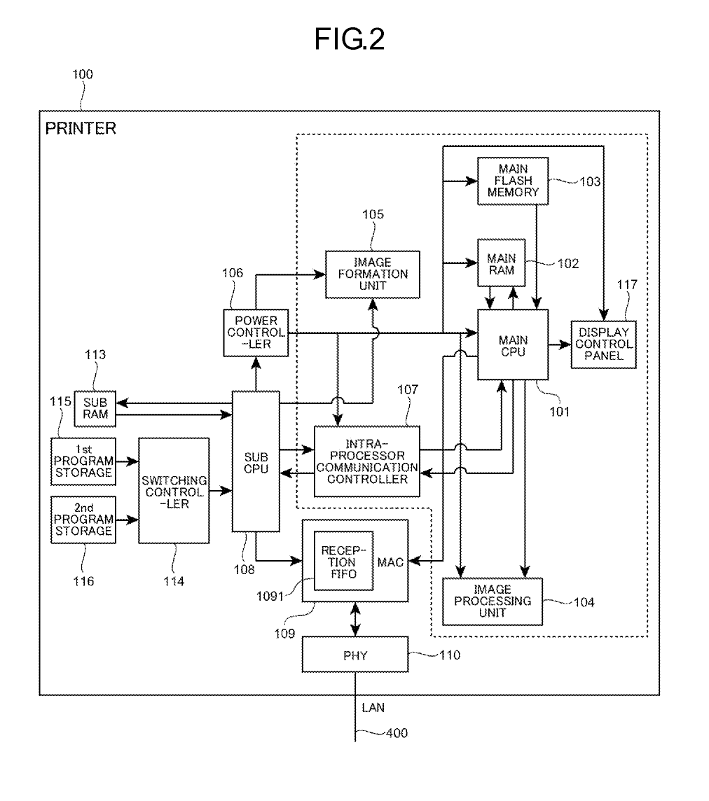

FIG. 2 is a block diagram showing the printer 100 in detail according to the first embodiment. In FIG. 2, the printer 100 includes a main CPU (Central Processing Unit) 101, a main RAM (Random Access Memory) 102, a main flash memory 103, an image processing unit 104, an image formation unit 105, a power controller 106, an intra-processor communication controller 107, a sub CPU 108, a MAC (Media Access Control unit) 109, a reception FIFO (first in first out) 1091, a PHY (Physical layer control unit) 110, a sub RAM 113, a switching controller 114, a first program storage 115, a second program storage 116, and a display control panel 117.

In this embodiment, the MAC 109 and the PHY serve as the reception unit 12; the reception FIFO 1091 serves as the reception buffer unit 14; the main CPU 101 and the sub CPU 108 serve as the control unit 10; the MAC 109 serves as the detection unit 16; the main CPU 101, the sub CPU 108, and the switching controller 114 serve as switching unit 18; the display control panel 117 serves as the control panel 20.

The main CPU 101 is a micro computer having a higher processing capability than the sub CPU 108. The main CPU 101 executes a control program (software) stored in the main flash memory 103, thereby controlling the whole operations of the printer 100 and realizing each function thereof. The main CPU 101 controls upon managing respective sections according to the functions, and when entering in a sleep mode, the main CPU 101 cuts off power supplies to the respective sections to save power of the printer 100. The main CPU 101 further has a clock function as a time measuring means.

The main RAM 102 is, e.g., a DRAM (Dynamic RAM). The main RAM 102 is a memory providing a necessary operation region when the main CPU 101 executes the control program, and has an adequately large capacity for this purpose. The main RAM 102 is set to a self-refresh mode during the sleep mode to reduce the power supply. The main flash memory 103 is a memory storing prescribed setting values for controlling the printer 100. The main flash memory 103 is a non-volatile memory retaining memorized contents even where the power supplied to the printer 100 is cut off.

The information processing unit 104 is a circuit doing prescribed processings on the printing data received from the PCs 200 as shown in FIG. 3 according to the instructions from the main CPU 101 and converting the processed data into printable data. The image formation unit 105 is a device, for forming images on a paper based on the printable data converted at the image processing unit 104, comprising a mechanical unit including such as, e.g., a motor, and image forming processing units forming images from electrical signals.

The power controller 106 is a circuit controlling entire power supplies in the printer 100. Thick solid lines and arrows indicate power supplies controllable respectively as to be supplied or cut off, in addition to the power supply to the entire portion, among the power supplies to the respective portions in the printer 100. A section surrounded by a broken line in FIG. 3 shows units subject to cutting off the power supply during the sleep mode.

The intra-processor communication unit 107 is a circuit controlling transmissions and receptions of various data such as, e.g., command (instruction) data sent between the main CPU 101 and the sub CPU 108. The sub CPU 108 is a micro computer having a power consumption less than that of the main CPU 101, controls in the normal mode the power controller 106 and the intra-processor communication unit 107, and controls in the sleep mode the power controller 106, the MAC 109, and the PHY 110. The sub CPU 108 further has a clock function as a time measuring means.

The MAC 109 as the reception unit 12 is a circuit controlling the media access control layer in network communication control with the LAN 400. The MAC 109 receives packet data (hereinafter, referred to as “packets”) for such as, e.g., broadcasting and multicasting from the PCs 200 shown in FIG. 3 via the LAN 400, and includes the reception FIFO 1091 serving as the reception buffer unit 14 for temporarily memorizing the received packets. The MAC 109 is controlled by the main CPU 101 in the normal mode, and is controlled by the sub CPU 108 in the sleep mode.

The reception FIFO 1091 is a reception buffer unit of a first-in first-out method to store the received packets such as, e.g., broadcasting and multicasting from the PCs 200 shown in FIG. 3 via the LAN 400. The received data of such as, e.g., broadcasting and multicasting are first stored in the reception FIFO 1091. The broadcasting and multicasting packets are packets for, e.g., inquiring the status of the printer 100. In a case of the sleep mode as the first mode, the sub CPU 108 serving as the control unit 10 reads out the received data stored in the reception FIFO 1091 and does prescribed processings such as, e.g., packet analysis in storing the data in the sub RAM 113.

In a case of the normal mode as the second mode, the main CPU 101 as the control unit 10 reads out the received data stored in the reception FIFO 1091 and does prescribed processings such as, e.g., packet analysis in storing the data in the main RAM 102.

The main CPU 101 and the sub CPU 108 thus constitute the control unit 10 of the printer 100; in the sleep mode, the sub CPU 108 does the prescribed processings whereas in the normal mode, the main CPU 101 and the sub CPU 108 do the prescribed processings. In the normal mode in which the main CPU 101 and the sub CPU 108 do the prescribed processings, the sub CPU 108 is in a state having a higher processing capability than that in the sleep mode for doing the prescribed processings.

The MAC 109 further has a function serving as the detection unit 16 for detecting the received data amount memorized and stored in the reception FIFO 1091, and detects that the received data memorized and stored in the reception FIFO 1091 reaches a prescribed amount. The PHY 110 is a circuit in charge of controlling the physical layer for the network communication control with the LAN 400. The PHY 110 is controlled by the main CPU 101 and the MAC 109 in the normal mode and controlled by the sub CPU 108 and the MAC 109 in the sleep mode.

The sub RAM 113 is an SRAM (static RAM), and is a memory providing an operation region necessary for executing the control program in the sub CPU 108. The sub RAM 113 has a small capacity because reducing the power consumption during the sleep mode. The switching controller 114 is a control circuit for switching the first program storage 115 and the second program storage 116, which are read only memories storing the control program (instruction) for the sub CPU 108, and the switching controller 114 executes switching according to the instruction from the main CPU 101.

The first program storage 115 is a memory storing the control program for the sub CPU 108 executed during the normal mode. The second program storage 116 is a memory storing the control program for the sub CPU 108 executed during the sleep mode. The control program for the sub CPU 108 executed during the sleep mode includes control programs (instructions) for the MAC 109 and the PHY 110, and protocol stacks for network communication control (transmission and reception control) with the LAN 400.

The display control panel 117 is a touch panel or the like, serving as a display unit for displaying, e.g., a setting screen and serving as an entry unit for receiving input manipulations done by the user such as for settings. In this embodiment, the display control panel 117 can accept entries for sleep mode setting, as described below, and entries by the user for setting and modifying the reception data amount memorized and stored in the reception FIFO 1091 to be detected with the MAC 109.

FIG. 4 is a screen illustration showing a sleep mode setting screen according to the first embodiment. In FIG. 4, a sleep mode setting screen 500 is a screen displayed only when the display control panel 117 shown in FIG. 2 receives an entry for sleep mode setting. The sleep mode can be set valid or invalid according to selection of valid or invalid buttons 501 on the sleep mode setting screen 500.

If a time is set in the sleep mode transition time box 502, a sleep mode transition time, or namely a prescribed time up to transit to the sleep mode, can be set. By pushing a save button 503, the contents set at the valid or invalid buttons 501 as well as the sleep mode transition time box 502, are saved in the main flash memory 103 shown in FIG. 2. By pushing a cancel button 504, the user can stop the sleep mode setting manipulation.

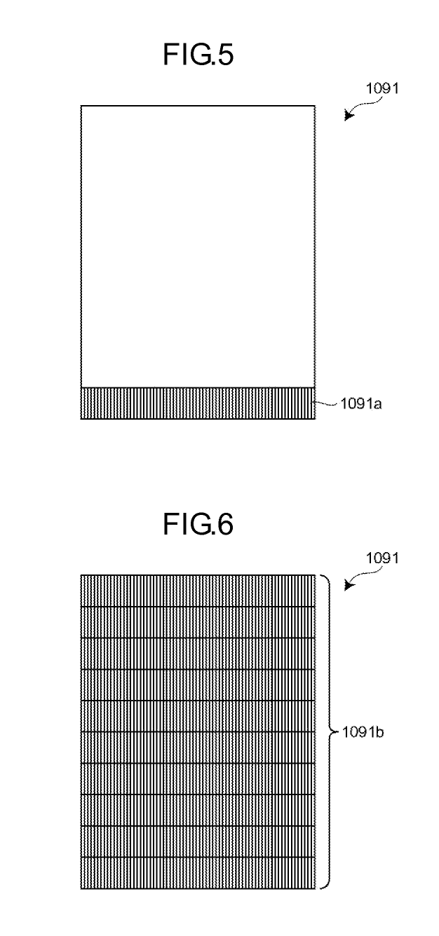

FIG. 5 and FIG. 6 are illustrations for describing the reception FIFO according to the first embodiment. FIG. 5 is a schematic diagram showing the reception FIFO 1091 in a state that the packet data 1091a stored in the reception FIFO 1091 of the printer 100 shown in FIG. 2 (hereinafter referred to as “stored data”) are in a small amount. As shown in FIG. 5, the stored data in the reception FIFO 1091 is in a state of the small amount, where the reception packet amount such as broadcasting or multicasting from the PCs 200 shown in FIG. 3 is relatively small or where the processing ability of the printer 100 during the sleep mode is adequately enough.

FIG. 6 is a schematic diagram showing the reception FIFO 1091 in a state that the stored data 1091b reach a full capacity in the reception FIFO 1091 of the printer 100 shown in FIG. 2. As shown in FIG. 6, the stored data in the reception FIFO 1091 becomes a full state, where the reception packet amount such as broadcasting or multicasting from the PCs 200 shown in FIG. 3 is relatively large or where the communication traffic on the LAN 400 is continuously overloaded above the processing ability of the printer 100 during the sleep mode.

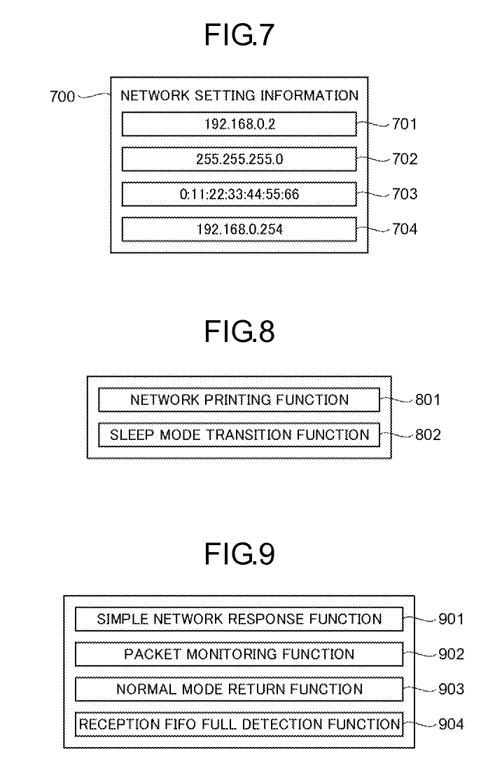

FIG. 7 is an illustration for describing network setting information according to the first embodiment. In FIG. 7, network setting information 700 is setting information regarding the network communication control assigned to the printer 100 shown in FIG. 1 to FIG. 3, and is constituted of an IP address 701, a subnet mask 702, a MAC address 703, and a gateway address 704.

The IP address 701 indicates the IP address (for example, 192.168.0.2) of the printer 100 shown in FIG. 2; the subnet mask 702 indicates the subnet mask (for example, 255.255.255.0) of the printer 100; the MAC address 703 indicates the MAC address (for example, 00:11:22:33:44:55:66) of the printer 100; the gateway address 704 indicates the gateway address (for example, 192.168.0.254) of the printer 100. The network setting information 700 is information used by the main CPU 101 or the sub CPU 108 shown in FIG. 3.

FIG. 8 is an illustration for describing printer's function in the normal mode according to the first embodiment. The printer 100 shown in FIG. 2 has a network printing function 801 and a sleep mode transition function 802 in the normal mode as shown in FIG. 8. The network printing function 801 and the sleep mode transition function 802 are executed by the main CPU 101 and the sub CPU 108 shown in FIG. 2. The network printing function 801 is a function for printing processing based on printing request (printing job) received via the LAN 400 shown in FIG. 3. The sleep mode transition function 802 is a function for controlling transition from the normal mode to the sleep mode.

FIG. 9 is an illustration for describing printer's function in the sleep mode according to the first embodiment. The printer 100 shown in FIG. 2 has a simple network response function 901, a packet monitoring function 902, a normal mode return function 903, and a reception FIFO full detection function 904, in the sleep mode as shown in FIG. 9. The simple network response function 901, the packet monitoring function 902, the normal mode return function 903, and the reception FIFO full detection function 904 are executed by the sub CPU 108 shown in FIG. 2. The simple network response function 901 is a function making responses to restricted communication protocols such as, e.g., ARP (Address Resolution Protocol)/ICMP (Internet Control Message Protocol) in the network communication control.

The packet monitoring function 902 is a function monitoring such as, e.g., packets for connection request to a TCP port waiting during the normal mode. The normal mode return function 903 is a function for controlling return to the normal mode. The reception FIFO full detection function 904 is a function for detecting that the reception FIFO 1091 of the MAC 109 shown in FIG. 2 enters in the full state. Detection that the reception FIFO 1091 becomes the full state can be set and modified upon reception of user's input manipulation on the display control panel 117 shown in FIG. 2.

The printer 100 shown in FIG. 3 thus formed, makes a transition from the normal mode to the sleep mode, where receiving no printing job via the LAN 400 or no entry of input manipulation on the display control panel 117 after the power is turned on and even after the sleep mode transition time set on the sleep mode setting screen 500 shown in FIG. 4 passes.

The transition processing from the normal mode to the sleep mode and the transition processing from the sleep mode to the normal mode are described hereinafter in reference to FIG. 2.

During the transition processing from the normal mode to the sleep mode, the main CPU 101 that completed a preparation processing for transition to the sleep mode, notifies an instruction to make a transition to the sleep mode to the sub CPU 108 via the intra-processor communication controller 107, thereby further performing the preparation processing for transition to the sleep mode. The sub CPU 108 that received the instruction to make the transition to the sleep mode, reads out the control program stored in the second program storage 116 according to the switching controller 114, and stops the power supply to the region shown with the broken line by means of the power controller 106, thereby making the transition to the sleep mode.

To the contrary, during the transition processing from the sleep mode to the normal mode, the sub CPU 108 reads out the control program stored in the first program storage 115 according to the switching controller 114, and further makes a transition to the normal mode upon beginning the power supply to the region shown with the broken line by means of the power controller 106. It is to be noted that the main CPU 101 enters into the normal mode with the power supply from the power controller 106.

The sub CPU 108 serving as a part of the switching unit 18 makes switching from the sleep mode to the normal mode, and also makes switching from the sleep mode to the normal mode when detecting that the received data stored in the reception FIFO 1091 in the MAC 109 reach the prescribed amount, based on the detection result of the received data stored in the reception FIFO 1091 in the MAC 109 while doing the prescribed processing in the sleep mode. In this embodiment, the printer 100 makes a transition from the sleep mode to the normal mode when detecting the full capacity state of the reception FIFO storing the packets received via the LAN 400 during the sleep mode.

In operation of this embodiment, first, the power is turned on at the printer 100 shown in FIG. 2 to start up the printer 100 with the normal mode. After transiting to the normal mode, the printer 100 then does a processing at a time when transiting to the sleep mode, and after transiting to the sleep mode, the printer 100 then does a processing to return to the normal mode upon detection of the full capacity state of the reception FIFO.

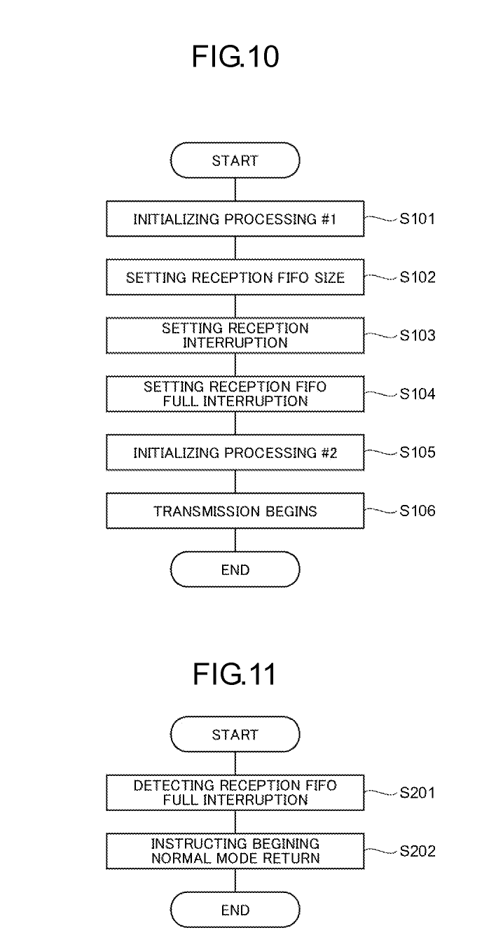

Referring to FIG. 2 and FIG. 10, an initialization processing done when the printer enters into the sleep mode is described according to steps shown with a letter S in a flowchart showing the flow of the initialization processing. It is to be noted that the initialization processing of the reception processing for the LAN 400 is mainly described and that other initialization processings are omitted for the sake of simplicity.

The sub CPU 108 of the printer 100 entering into the sleep mode, does an initialization processing for such as, e.g., the sub RAM 113 (step S101) as initialization processing #1. The sub CPU 108 then sets a size or capacity of the reception FIFO 1091 to a register in the MAC 109 (step S102). The sub CPU 108 sets a reception interruption setting to the register in the MAC 109 (step S103). Where this reception interruption setting is made, the MAC 109 generates an interruption to the sub CPU 108 at each reception of the packets via the LAN 400.

The sub CPU 108 sets a reception FIFO full interruption setting to the register in the MAC 109 (step S104). Where this reception FIFO full interruption setting is made, an interruption to the sub CPU 108 is generated when the received packets reach the size set by the reception FIFO 1091. The sub CPU 108 then does other initialization processing as initialization processing #2 at step S105. The sub CPU 108 begins network transmission and reception control with the MAC 109 and the PHY 110 at step S106, thereby finishing this processing.

Referring to FIG. 2 and FIG. 11, a processing done with the sub CPU when the reception FIFO reaches the full state where the printer is in the sleep mode is described according to steps shown with a letter S in a flowchart showing the flow of the processing at a time of an occurrence of the reception FIFO's full state during the sleep mode.

The reception FIFO full interruption is generated to the sub CPU 108 where the stored data are accumulated in the reception FIFO 1091 to render the reception FIFO 1091 in the full state, or namely where the received data memorized in the reception FIFO 1091 reach the full capacity amount (step S201). If communication traffic exceeding the processing capacity of the printer 100 during the sleep mode occurs on the LAN 400, the condition for generating the reception FIFO full interruption is satisfied.

The sub CPU 108 notifies returning to the normal mode to the power controller 106; the power controller 106 supplies electric power to the entire printer 100 to return to the normal mode; the main CPU 101 continuously performs the network communication control (S202). Thus, the printer 100 returns from the sleep mode to the normal mode when detecting the full state of the reception FIFO 1091 storing the packets received via the LAN 400 during the sleep mode, so that the printer 100 can suppress occurrences of packet reception failures even where the communication traffic becomes subjecting to heavy load during the sleep mode.

As described above, with the first embodiment, the printer returns from the sleep mode to the normal mode when detecting the full state of the reception FIFO during the sleep mode, and the printer can advantageously suppress occurrences of packet reception failures even where the communication traffic becomes subjecting to heavy load during the sleep mode.

### Second Embodiment

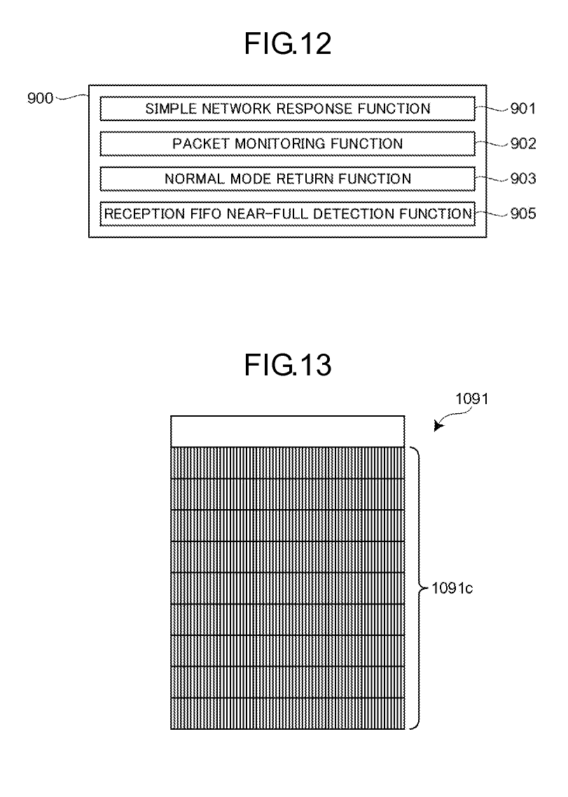

A function that the printer has during the sleep mode according to the second embodiment is different from that of the first embodiment. The structure according to the second embodiment is described with reference to FIG. 12, an illustration for describing printer's function in the sleep mode. Other functions in the second embodiment are substantially the same as those in the first embodiment described above. The portions substantially the same as those in the first embodiment are omitted from the description below for the sake of simplicity, while the same reference numbers are assigned.

FIG. 12 is an illustration for describing printer's function in the sleep mode according to the second embodiment. The printer 100 shown in FIG. 3 has a simple network response function 901, a packet monitoring function 902, a normal mode return function 903, and a reception FIFO near-full detection function 905, in the sleep mode as shown in FIG. 12. The simple network response function 901, the packet monitoring function 902, the normal mode return function 903, and the reception FIFO near-full detection function 905 are executed by the sub CPU 108 shown in FIG. 2.

The reception FIFO near-full detection function 905 is a function for detecting that the reception FIFO 1091 shown in FIG. 2 enters in a nearly full state. Detection that the reception FIFO 1091 becomes the nearly full state, or namely a prescribed amount of the received data to be decided as the near-full state of the reception FIFO 1091, can be set and modified upon reception of user's input manipulation on the display control panel 117 shown in FIG. 2.

FIG. 13 is an illustration of a reception FIFO 1091 showing that the stored data 1091c reach a nearly full state (hereinafter referred as to “near-full” or “near-full state”) in the reception FIFO 1091 in the printer 100 shown in FIG. 3. The near-full state herein means a state that the capacity of the reception FIFO 1091 does not reach the full state yet but an empty region for retaining the stored data is in a very small amount. The stored data in the reception FIFO 1091 come to enter in the near-full state as shown in FIG. 13 where the received packet amount such as, e.g., broadcasting and multicasting, from the PCs 200 shown in FIG. 3 is relatively large, or where a state of the communication traffic on the LAN 400 exceeding the processing capacity of the printer 100 during the sleep mode, continues.

In this embodiment, when the printer 100 detects the near-full state of the reception FIFO 1091 storing the received packets via the LAN 400 during the sleep mode, the printer 100 makes a transition from the sleep mode to the normal mode.

In operation of the second embodiment, first, the power is turned on at the printer 100 shown in FIG. 3 to start up the printer 100 with the normal mode. After transiting to the normal mode, the printer 100 then does a processing at a time when transiting to the sleep mode, and after transiting to the sleep mode, the printer 100 then does a processing to return to the normal mode upon detection of the near-full state of the reception FIFO.

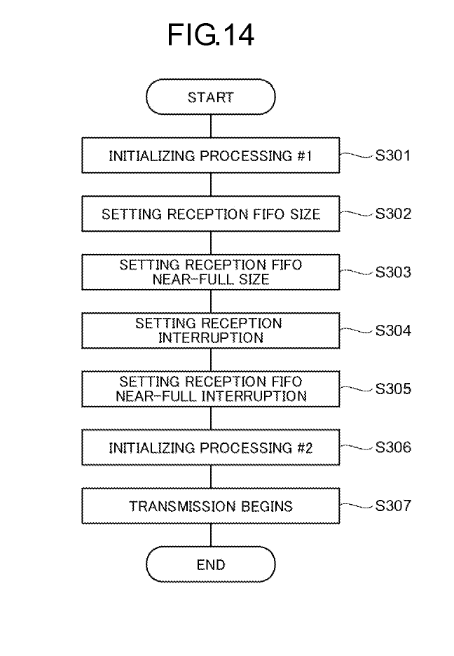

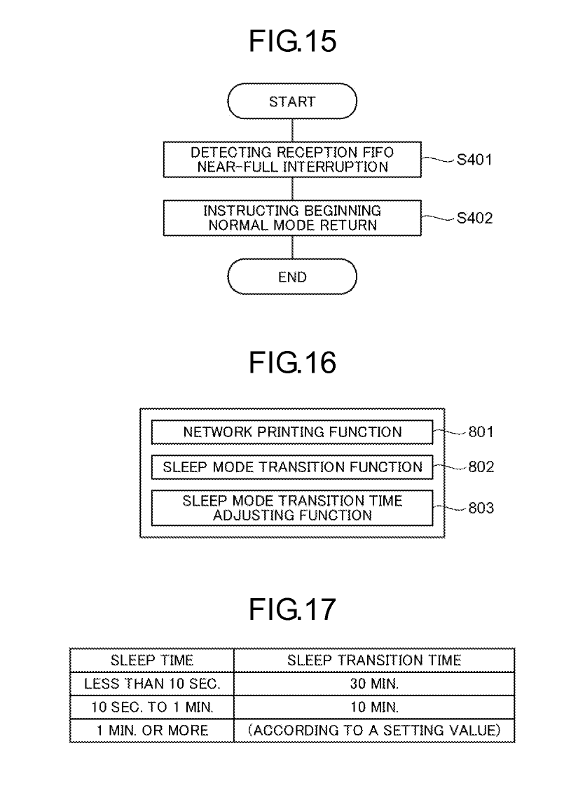

First, referring to FIG. 2 and FIG. 14, an initialization processing done when the printer enters into the sleep mode is described according to steps shown with a letter S in a flowchart showing the flow of the initialization processing. It is to be noted that the initialization processing of the reception processing for the LAN 400 is mainly described and that other initialization processings are omitted for the sake of simplicity.

Processings done at steps S301, S302 are substantially the same as those at S101, S102 shown in FIG. 10, and the description is omitted for the sake of simplicity. The sub CPU 108 sets a size of the reception FIFO near-full capacity in the register of the MAC 109 (step S303). With this embodiment, the printer 100 can avoid delayed processings of the network communication control during the sleep mode by setting the size of the reception FIFO near-full capacity to be an appropriate value. It is to be noted that the size of the reception FIFO near-full capacity can be modified by setting manipulations entered from the display control panel 117. The sub CPU 108 sets a reception interruption setting to the register in the MAC 109 (step S304). When this reception interruption setting is done, the MAC 109 generates an interruption to the sub CPU 108 at each reception of the packets via the LAN 400.

The sub CPU 108 sets the reception FIFO near-full interruption setting to the register in the MAC 109. When this reception FIFO near-full interruption setting is done, the reception FIFO 1091 receives packets upon the set size and generates an interruption where reaching the near-full state. Processings done at steps S306, S307 are substantially the same as those at S105, S106 shown in FIG. 10, and the description is omitted for the sake of simplicity.

Next, a processing done with the sub CPU 108 when the printer is in the sleep mode and when the reception FIFO reaches the near-full state, is described according to steps shown with a letter S in a flowchart showing the flow of the processing at a time of occurrences of the near-full state of the reception FIFO during the sleep mode according to the second embodiment, with reference to FIG. 2.

The reception FIFO near-full interruption is generated to the sub CPU 108 where the stored data are accumulated in the reception FIFO 1091 to render the reception FIFO 1091 in the near-full state, or namely where the received data memorized in the reception FIFO 1091 reach the nearly full capacity amount (step S401). If communication traffic exceeding the processing capacity of the printer 100 during the sleep mode occurs on the LAN 400, the condition for generating the reception FIFO near-full interruption is satisfied.

The sub CPU 108 notifies returning to the normal mode to the power controller 106; the power controller 106 supplies electric power to the entire printer 100 to return to the normal mode; the main CPU 101 continuously performs the network communication control (S402). Thus, the printer 100 returns from the sleep mode to the normal mode when detecting the near-full state of the reception FIFO 1091 storing the packets received via the LAN 400 during the sleep mode, so that the printer 100 can suppress occurrences of packet reception failures even where the communication traffic becomes subjecting to heavy load during the sleep mode.

Where the printer 100 is connected to the switching hub 300 in which a spanning tree function is valid, the printer 100 is prevented from suffering a dead link by suppressing the transition from the normal mode to the sleep mode, thereby improving usability of the printer 100.

As described above, with the second embodiment, in addition to the advantages of the first embodiment, where the printer is connected to the switching hub in which a spanning tree function is valid, the printer is prevented from suffering a dead link by suppressing the transition from the normal mode to the sleep mode, thereby advantageously improving usability of the printer.

### Third Embodiment

A function that the printer has during the normal mode according to the second embodiment is different from that of the first embodiment. The structure according to the third embodiment is described with reference to FIG. 16, an illustration for describing printer's function in the normal mode. Other functions in the third embodiment are substantially the same as those in the first embodiment described above. The portions substantially the same as those in the first embodiment are omitted from the description below for the sake of simplicity, while the same reference numbers are assigned.

FIG. 16 is an illustration for describing printer's function in the normal mode according to the third embodiment. The printer 100 shown in FIG. 3 has a network printing function 801, a sleep mode transition function 802, and a sleep mode transition time adjusting function 803, as shown in FIG. 16, during the normal mode. The sleep mode transition time adjusting function 803 is a function that the controller looks up a sleep mode transition time decision table memorized in the main flash memory shown in FIG. 2 and adjusts a transition time to a subsequent sleep mode according to a combination of a cause returning from the sleep mode and a sleep time as a time of lapse from the transition from the normal mode to the sleep mode.

FIG. 17 is the sleep mode transition time decision table according to the third embodiment. The sleep mode transition time decision table shown in FIG. 17 is a data table memorized in the first program storage as shown in FIG. 2, and is used for deciding a subsequent sleep mode transition time according to the sleep time described above. The contents of the sleep mode transition time decision table can be set and modified upon receiving user's input manipulations on the display control panel 117 as shown in FIG. 2. The initial value (default value) of the sleep transition time of the sleep mode transition time decision table is 15 minutes.

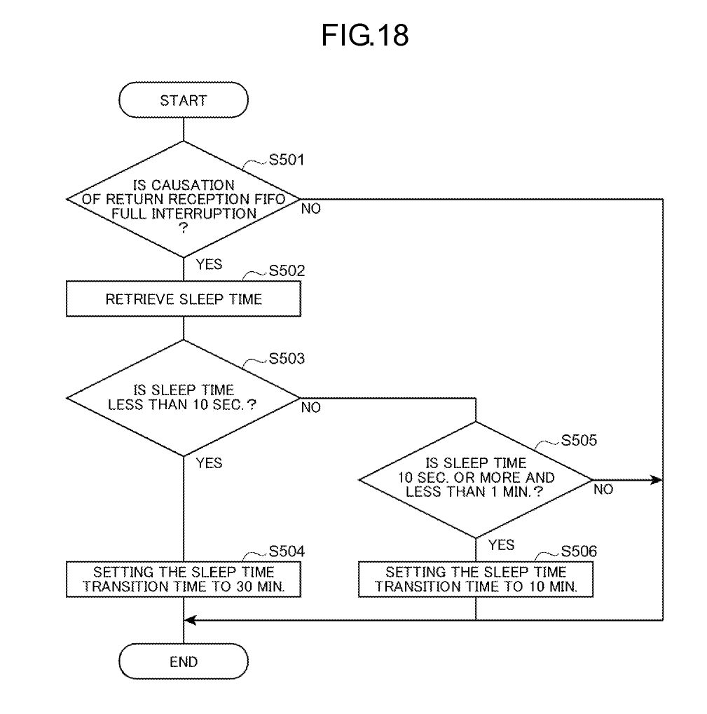

In operation of the third embodiment, first, a sleep mode transition time decision processing done with the sub CPU when the printer enters into the normal mode is described, in referring to FIG. 2 and FIG. 17, according to steps shown with a letter S in a flowchart showing the flow of the sleep mode transition time decision processing in FIG. 18. It is to be noted that the processings at a time of transiting to the sleep mode and of returning to the normal mode are substantially the same as those in the first embodiment, and their description is omitted for the sake of simplicity.

The substrate CPU 108 judges as to whether the cause of return from the sleep mode to the normal mode is the reception FIFO full interruption (S501). If the cause of return is judged as the reception FIFO full interruption, the processing goes to step S502, and if the cause of return is not judged as the reception FIFO full interruption, this processing ends. The sub CPU 108 judging as that the cause of return is the reception FIFO full interruption, retrieves a measured sleep time (step S502).

The sub CPU 108 retrieving the sleep time looks up the sleep mode transition time decision table and judges as to whether the sleep time is less than ten (10) seconds (S503). If it is judged as less than ten seconds, the processing goes to step S504, and if it is judged as not less than ten seconds, the processing goes to step S505. At step S504, the sub CPU 108 judging as that the sleep time is less than ten seconds, looks up the sleep mode transition time decision table and sets the sleep time to thirty minutes, thereby finishing this processing.

In this embodiment, although the substrate CPU 108 looks up the sleep mode transition time decision table at step S503 and judges as to whether the sleep time is less than ten seconds, the substrate CPU 108 may judge as to whether the currently set sleep transition time is less than thirty minutes. If the sleep time is judged as less than ten seconds and if the currently set sleep transition time is judged as less than thirty minutes, the sub CPU 108 may set the sleep transition time to thirty minutes, and may end this processing.

The sub CPU 108 judging that the sleep time is not less than ten seconds, looks up the sleep mode transition time decision table at step S505. The sub CPU 108 judges as to whether the sleep time is equal to or more than ten seconds and is less than one minute, and if it is judged as equal to or more than ten seconds and is less than one minute, the processing goes to step S506. If the sub CPU 108 judges that the sleep time is equal to or more than ten seconds but not less than one minute, the CPU 108 does not change the sleep transition time and utilizes a set value set on the sleep mode setting screen in FIG. 4, and ends this processing. The sub CPU 108 judging that the sleep time is equal to or more than ten seconds and is less than one minute (step S506), looks up the sleep mode transition time decision table, sets the sleep transition time to ten minutes, and ends this processing.

Although in this embodiment the sub CPU 108 looks up the sleep mode transition time decision table at step S505 and judges as to whether the sleep time is equal to or more than ten seconds and is less than one minute, the sub CPU 108 may judge as to whether the sleep time is equal to or more than ten seconds and is less than one minute and as to whether the currently set sleep transition time is less than ten minutes. If it is judged that the sleep time is equal to or more than ten seconds and is less than one minute and that the currently set sleep transition time is less than ten minutes, the sub CPU 108 may set the sleep transition time to ten minutes and may end this processing.

The printer 100 thus changes the sleep mode transition time extending until the transition to the sleep mode according to the lapse of time from the transition to the sleep mode, or namely, renders longer the sleep mode transition time extending until the subsequent transition to the sleep mode where the lapse of time from the transition to the sleep mode is short, so that processings can be executed as much as possible during the normal mode with the higher processing capability.

As described above, in the third embodiment, in addition to the advantages of the first embodiment, the sleep mode transition time extending until the transition to the sleep mode is changed according to the lapse of time from the transition to the sleep mode, so that processings can be advantageously executed as much as possible during the normal mode with the higher processing capability.

### Fourth Embodiment

A function that the printer has during the normal mode according to the fourth embodiment is different from that of the second embodiment. The structure according to the fourth embodiment is substantially the same as that shown in the illustration for describing printer's function in the normal mode according to the third embodiment as shown in FIG. 16. Other functions in the fourth embodiment are substantially the same as those in the second embodiment described above. The portions substantially the same as those in the second embodiment are omitted from the description below for the sake of simplicity, while the same reference numbers are assigned. The printer according to the fourth embodiment includes a sleep mode transition time decision table shown in FIG. 17 in the same manner as in the third embodiment.

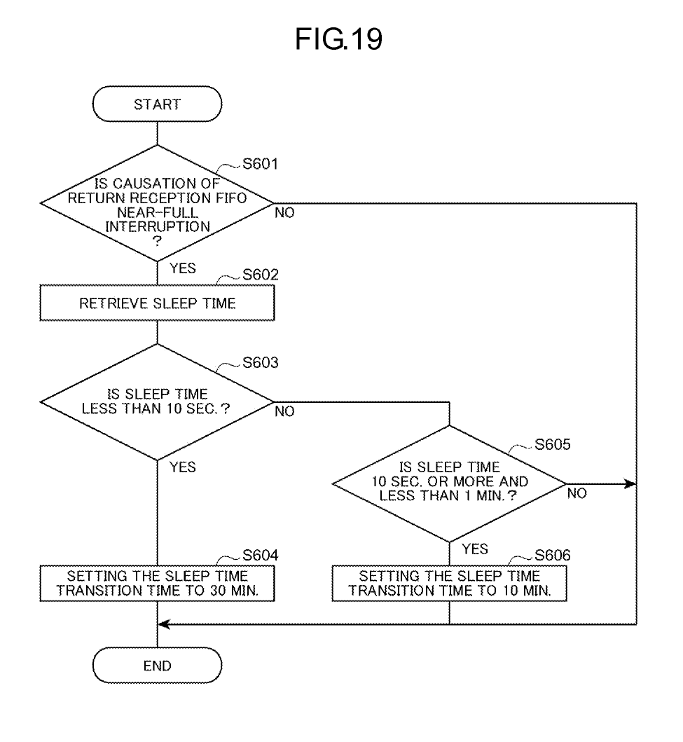

In operation of the fourth embodiment, first, a sleep mode transition time decision processing done with the sub CPU when the printer enters into the normal mode is described, in referring to FIG. 2 and FIG. 17, according to steps shown with a letter S in a flowchart showing the flow of the sleep mode transition time decision processing in FIG. 19. It is to be noted that the processing when transiting to the sleep mode and the processing returning to the normal mode are substantially the same as those in the second embodiment, and are omitted from the description.

The sub CPU 108 judges as to whether the cause of return from the sleep mode to the normal mode is the reception FIFO near-full interruption (step S601), and if the cause of return is judged as the reception FIFO near-full interruption, the processing goes to step S602, whereas if the cause of return is not judged as the reception FIFO near-full interruption, the sub CPU 108 ends the processing.

The sub CPU 108 judging that the cause of return is the reception FIFO near-full interruption, retrieves a measured sleep time (step S602). The sub CPU 108 retrieving the sleep time, looks up the sleep mode transition time decision table, judges as to whether the sleep time is less than ten seconds, and if it is judged as less than ten seconds, the processing goes to step S604 whereas if it is judged as not less than ten seconds, the processing goes to step S605.

The sub CPU 108 judging that the sleep time is less than ten seconds, looks up the sleep mode transition time decision table, sets the sleep transition time to thirty minutes, and ends this processing. In this embodiment, although at step S603, the sub CPU 108 looks up the sleep mode transition time decision table and judges as to whether the sleep time is less than ten seconds, the sub CPU may judge as to whether the sleep time is less than ten seconds and whether the currently set sleep transition time is less than thirty minutes. If the sleep time is judged as less than ten seconds and if the currently set sleep transition time is judged as less than thirty minutes, the sub CPU 108 may set the sleep transition time to thirty minutes, and may end the processing.

The sub CPU 108 judging that the sleep time is not less than ten seconds, looks up the sleep mode transition time decision table at step S605. The sub CPU 108 judges as to whether the sleep time is equal to or more than ten seconds and is less than one minute, and if it is judged as equal to or more than ten seconds and is less than one minute, the processing goes to step S606. If the sub CPU 108 judges that the sleep time is equal to or more than ten seconds but not less than one minute, the CPU 108 does not change the sleep transition time and utilizes a set value set on the sleep mode setting screen in FIG. 4, and ends this processing. The sub CPU 108 judging that the sleep time is equal to or more than ten seconds and is less than one minute, looks up the sleep mode transition time decision table (S606), sets the sleep transition time to ten minutes, and ends this processing.

Although in this embodiment the sub CPU 108 looks up the sleep mode transition time decision table at step S605 and judges as to whether the sleep time is equal to or more than ten seconds and is less than one minute, the sub CPU 108 may judge as to whether the sleep time is equal to or more than ten seconds and is less than one minute and as to whether the currently set sleep transition time is less than ten minutes. If it is judged that the sleep time is equal to or more than ten seconds and is less than one minute and that the currently set sleep transition time is less than ten minutes, the sub CPU 108 may set the sleep transition time to ten minutes and may end this processing.

The printer 100 thus changes the sleep mode transition time extending until the transition to the sleep mode according to the lapse of time from the transition to the sleep mode, or namely, renders longer the sleep mode transition time extending until the subsequent transition to the sleep mode where the lapse of time from the transition to the sleep mode is short, so that processings can be executed as much as possible during the normal mode with the higher processing capability. The printer 100 further can return to the normal mode even where high load communication traffic of the network occurs which is close to a limitation of the processing capability of the printer during the sleep mode, so that the printer can suppress occurrences of packet reception failures.

As described above, in the fourth embodiment, in addition to the advantages of the second embodiment, the sleep mode transition time extending until the transition to the sleep mode is changed according to the lapse of time from the transition to the sleep mode, so that processings can be advantageously executed as much as possible during the normal mode with the higher processing capability.

The printer further can return to the normal mode even where high load communication traffic of the network occurs which is close to a limitation of the processing capability of the printer during the sleep mode, so that the printer can advantageously suppress occurrences of packet reception failures. It is to be noted that although in the first to fourth embodiments the information processing apparatus is described as a printer, the invented apparatuses are not limited to this, and are applicable to apparatuses having communication ability such as, e.g., personal computers, server computers, photocopiers, facsimile machines, and multifunction peripherals (MFPs), which are connected to a communication line or lines.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. An information processing apparatus comprising:
a reception unit for receiving data;
a reception buffer unit memorizing the data received at the reception unit;
a control unit reading out the data from the reception buffer unit and executing a prescribed processing in either a first mode or a second mode having a higher processing ability than that of the first mode;
a detection unit for detecting an amount of the data memorized in the reception buffer unit; and
a switching unit for switching, based on a detection result of the detection unit, the first mode to the second mode while the control unit is executing the processing in the first mode.

2. The information processing apparatus according to claim 1, wherein the switching unit switches the first mode to the second mode when the control unit is executing the processing in the first mode and when the detection unit detects that the amount of the data memorized in the reception buffer unit reaches a prescribed amount.

3. The information processing apparatus according to claim 2, wherein the prescribed amount is a full amount of data capacity of the reception buffer unit.

4. The information processing apparatus according to claim 2, wherein the prescribed amount is a nearly-full amount of data capacity of the reception buffer unit.

5. The information processing apparatus according to claim 2, wherein the prescribed amount is changeable according to user's manipulation.

6. The information processing apparatus according to claim 1, wherein the switching unit sets a transition time for a subsequent transition to the first mode based on lapse of time from the transition to the first mode when the switching unit switches the first mode to the second mode.

7. The information processing apparatus according to claim 6, wherein the transition time is changeable according to user's manipulation.

8. The information processing apparatus according to claim 6, wherein the switching unit makes the transition time longer as the lapse of time is shorter.

9. A mode switching method used in an information processing apparatus, comprising the steps of:
receiving data at a reception unit;
memorizing, in a reception buffer unit, the data received the reception unit;
reading out the data from the reception buffer unit to a control unit and executing a prescribed processing at the control unit in either a first mode or a second mode having a higher processing ability than that of the first mode;
detecting, at a detection unit, an amount of the data memorized in the reception buffer unit; and
switching, based on a detection result of the detection unit, the first mode to the second mode while the control unit is executing the processing in the first mode.

10. The mode switching method according to claim 9, wherein switching is made at a switching unit from the first mode to the second mode when the control unit is executing the processing in the first mode and when the detection unit detects that the amount of the data memorized in the reception buffer unit reaches a prescribed amount.
